(19) United States
(12) Patent Application Publication
(10) Pub. No.: US 2025/0015750 A1
(43) Pub. Date: Jan. 9, 2025

(54) MOBILE, SCALABLE SELF-POWERED AGRIVOLTAIC SYSTEM

(71) Applicant: THE REGENTS OF THE UNIVERSITY OF CALIFORNIA, Oakland, CA (US)

(72) Inventors: Reza Ehsani, Merced, CA (US); Ricardo de Castro, Merced, CA (US); Mohammadmehdi Maharlooei, Merced, CA (US)

(73) Assignee: THE REGENTS OF THE UNIVERSITY OF CALIFORNIA, Oakland, CA (US)

(21) Appl. No.: 18/764,981

(22) Filed: Jul. 5, 2024

Related U.S. Application Data
(60) Provisional application No. 63/512,026, filed on Jul. 5, 2023.

(51) Int. Cl. H02S 20/32; A01G 25/09; H02S 40/38

(52) U.S. Cl. CPC H02S 20/32; A01G 25/09; H02S 40/38

(57) ABSTRACT

A mobile, modular shading and solar generation platform and system that provides adjustable shade for crops sensitive to excessive sunlight or as mobile paddock system for animals while optimizing power generation. The system has a platform with solar panels and shade panels that is supported by motorized mobile towers with batteries for electrical storage and transfer. The system can be equipped with different environmental sensors to detect biotic and abiotic stress in plants and control shading needs. Use of mobile, adjustable shading will reduce plant water use by decreasing the evapotranspiration rate. The platform may also include an irrigation system for controlled watering and growth lights to improve crop growth rate and quality. The system may also include a master controller for controlled movement of the apparatus structure, irrigation, sensor data and electricity transfer.

### CROSS-REFERENCE TO RELATED APPLICATIONS

This application claims priority to, and the benefit of, U.S. provisional patent application Ser. No. 63/512,026 filed on Jul. 5, 2023, incorporated herein by reference in its entirety.

### STATEMENT REGARDING FEDERALLY SPONSORED RESEARCH OR DEVELOPMENT

Not Applicable

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

The technology of this disclosure pertains generally to photovoltaic power generation systems and more particularly to a scalable, mobile, agrivoltaic system and methods to provide adjustable shade for labor working inside the field, animals, or and crops sensitive to excessive sunlight while generating electrical power at the same time. The system is modular and multiple modules can be coordinated to optimize both electrical generation and overall crop irradiation. The solar shading system also has the option of adding LED light sources of blue and red bands at night to improve and expedite crop growth rate and quality. Additionally, the shaded area can be used for managed grazing of livestock.

### 2. Background Discussion

Current photovoltaic power generation systems require large arrays of panels for practical electrical generation. However, large arrays of panels are not feasible in an urban setting due to poor power generation to panel area ratios, inconsistent light exposures, interference due to high panel reflectivity and poor system aesthetics. Therefore, open, generally flat terrain is the ideal setting for large arrays of panels and such flat terrain is often also good as productive farmland or orchard lands. Removal of prime productive farmland for solar power electricity generation may be counterproductive overall.

However, it has been shown that the amount of total illumination that is needed for photosynthesis will differ depending on the type of plant. Photosynthesis with solar illumination will increase to a saturation point where photosynthesis peaks and increased illumination will not increase the photosynthesis of the crop any further. Therefore, the total energy from the sun could be shared between crops and solar panels without diminishing crop production.

Furthermore, excessive heat during summer months can damage and prevent the growth of certain crops, such as some fruits and vegetables, in dry areas. Excessive solar exposure or heat exposure may also cause sunburned leaves or fruit damage that reduces the quality of fruits as well as the yield. For example, sunburn necrosis or sunburn browning in plums or sunscald in apple fruits are well known damage conditions from solar overexposure.

Current strategies for alleviating the problem of overexposures to sun and heat include providing extra water to the crops during hot days, applying kaolin clay spray, using overhead sprinklers, and using shade netting to reduce harmful overexposures. However, some solutions, such as applying additional water, are not viable in areas with seasonal water shortages or limited water availability. Other solutions, such as using the shade nets or spraying kaolin, are also very labor-intensive and costly approaches.

Another strategy is to control the soil surface temperature by cultivating cover crops. These cover crops are intended to mitigate heat loss by improving soil health through the introduction of high levels of organic matter and biomass. However, these cover crops can decrease the amount of available soil water, consume soil nutrients and increase the risk of frost in spring.

Thus, there is a need for systems and methods that allow control over overall illumination and overexposures of food crops and reducing water demand while optimizing solar electrical generation simultaneously.

### BRIEF SUMMARY

A scalable, mobile, agrivoltaic system, apparatus and methods to produce adjustable shade for crops sensitive to excessive sunlight, such as most fruits and vegetables on sunny days and generate electricity for the system and controlled movement of the apparatus structure is provided. Use of mobile, adjustable shading will reduce plant water use by decreasing the evapotranspiration rate. The system also provides control over the temporal and the overall irradiation of food crops permitting optimal growing solar exposures and avoiding damaging overexposures. This system also has the option of adding LED light sources of blue and red bands at night to improve and expedite crop growth rate and crop quality.

In addition, the system can be equipped with different types of plant sensors that can monitor plant growth rates and detect plant biotic and abiotic stresses. Sensor signals and programming provide control over the time of day and the length of time the crops that are sensitive to excessive sunlight are within the adjustable shade of the structure. The system can be centrally located for collecting and processing agricultural field data and wirelessly transferring the data to a central location.

Furthermore, the shading structure can be used for an automated containment cell or moving paddock capable of holding grazing animals for managed grazing. This system can move incrementally several times a day to increase the efficiency, productivity, and sustainability of the intensive grazing system while reducing the adverse effects of intensive grazing. The mobile paddock system contains a water trough with a system of pumps to fill the water trough from a larger tank that will be refilled automatically.

The apparatus of the system is also modular so that modules can work in concert with each other as well as independently. For example, in one embodiment, individual modules are configured with water distribution pipes and sprinklers for delivery of spray to plants or animals below the structure. The water distribution pipes of each of the modules in the system may be interconnected and at least one module is connected to an existing pressurized irrigation system to provide a source of water. Water delivered in the shade of the structure can reduce evaporation during delivery and conserve water as well as allow for focused watering of plants. In one embodiment, the irrigation system is controlled through a series of sensors that can detect water stress and precisely irrigate the plants based on their need.

In one embodiment, the system apparatus comprises a lightweight beam structure installed on a series of self-propelled vertical towers or columns that make the structure mobile. The top of the beam structure is covered by a series of solar panels that may provide electricity for the system and platform mobility. This system can also be augmented by other renewable sources such as regular or vertical wind turbines to charge the batteries, provide electricity to the grid or to produce products such as hydrogen.

The towers are preferably equipped with two or four tires or undercarriage tracks. The tires/tracks are driven by electric motors and a gearbox or by a hydraulic power driver. The movement of the tires/tracks and towers are preferably controlled through a Main Control Unit (MCU). In one embodiment, the wheels rotate on an established rail or within a channel/track that determines the direction of movement of the apparatus by the wheels.

In another embodiment, the columns are telescoping columns that are coupled to each corner of the planar beam structure with a ball joint or other pivoting joint that allows the beam structure to move relative to the column. In this embodiment, the extension or retraction of each of the columns changes the position of the plane of the beam platform structure. The telescoping columns or towers also allow the plane of the platform structure to remain level when the wheels are on uneven or irregular soil surfaces.

The system architecture may also include a planar array of rows of solar photovoltaic panels that can be dynamically oriented for optimum solar collection. The solar panels or rows can move around an axis and be adjusted to follow the sun in the sky to produce maximum energy in this embodiment. The solar panels of the array may also be stationary or spaced apart to reduce the passage of sunlight through the array to the surface of the ground.

In another embodiment, the array may also include solid or corrugated sheets spaced apart in the plane of the array to provide some control and limitations over the total quantity of sunlight that is available to the crops. The sheet or shade panels may be moveable or removable so the amount of light passing through the panel at any given time can be configured.

In one embodiment, the system structure can act as a physical barrier to extreme weather events such as hail or heavy rains as well as a protection against frost conditions. For example, the mobile platform can be positioned over frost-sensitive plants or grazing animals and later moved to allow full sun when temperatures rise. Likewise, several mobile modules can be brought together to provide a physical barrier to rain or hail over plants in danger of storm damage and the mobile platform modules can be re-deployed when the storms have passed.

In another embodiment, the electrical production may be diversified to be part of a system with electrical production from several different sources added to the platform, such as wind turbines. The system may also include the production of hydrogen for fuel cells or the secondary production of hydrogen. Supplementary fuel for fuel cells or hydrogen powered tractors, robots, and drones can be made available or provide an emergency secondary source of electricity.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE DRAWINGS

The technology described herein will be more fully understood by reference to the following drawings which are for illustrative purposes only:

FIG. 1 is a schematic perspective view of a mobile shade and power module structure with an enlarged view of a moving carriage portion and an enlarged partial view of a tower at the corner of the platform support platform with water lines and solar panels according to one embodiment of the technology.

FIG. 2 is a schematic top perspective view of the panel support platform portion of the system shown in FIG. 1 prior to the installation of the solar panels. Dimensions are examples and are shown in feet.

FIG. 3 is a schematic side plan view of the panel support platform shown in FIG. 2.

FIG. 4 is a schematic top plan view of portion of the panel support platform shown in FIG. 2.

FIG. 5 is a schematic perspective view of portion of the panel support platform shown in FIG. 3 and FIG. 4 with an enlargement detail of the joints of the platform structure according to one embodiment of the technology.

FIG. 6 is a schematic top perspective view of an alternative mobile shade and power hub structure with partial views of the columns configured with track movers and optional corrugated shade panels with LED grow lights according to another embodiment of the technology.

FIG. 7 is a partial view of a carriage tower portion of the system shown in FIG. 1 illustrating the linear irrigation pipe structure, electric motor and gearbox assembly and the solar platform coupling stand according to one embodiment of the technology.

FIG. 8 is a block diagram of an embodiment of the Main Control Unit (MCU) that operates the mobile agrivoltaic system according to one embodiment of the technology.

### DETAILED DESCRIPTION

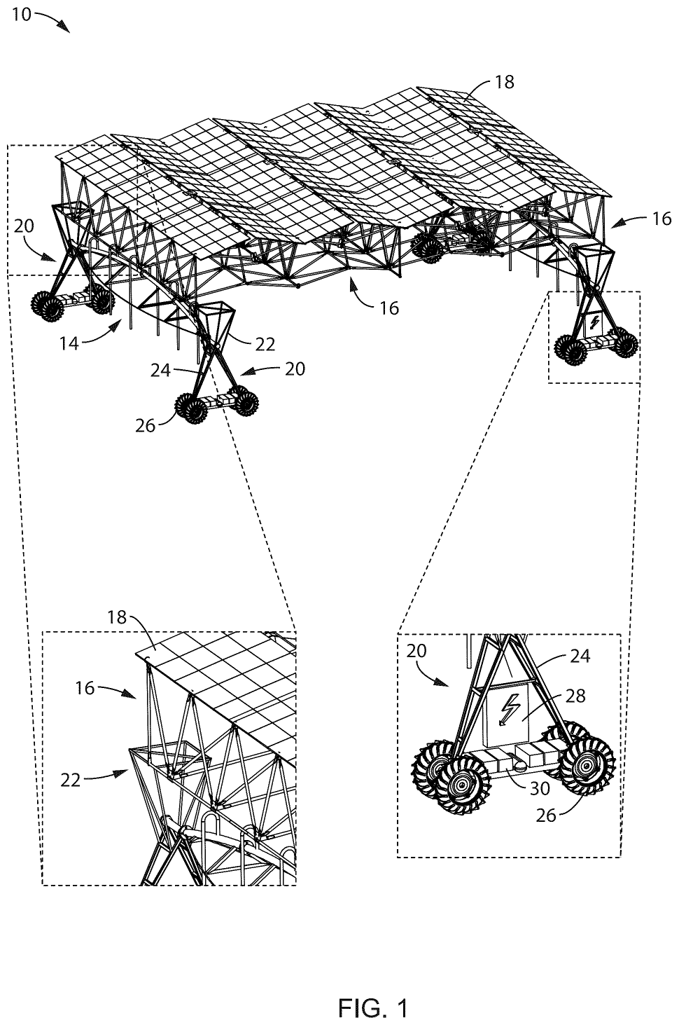

Referring more specifically to the drawings, for illustrative purposes, devices, systems and methods for dynamic shading of heat sensitive crops and optimized solar power generation are generally shown. Several embodiments of the technology are described generally in FIG. 1 to FIG. 8 to illustrate the characteristics and functionality of the mobile, self-powered agrivoltaic system apparatus and methods. It will be appreciated that the methods may vary as to the specific steps and sequence and the systems and apparatus may vary as to structural details without departing from the basic concepts as disclosed herein. The method steps are merely exemplary of the order that these steps may occur. The steps may occur in any order that is desired, such that it still performs the goals of the claimed technology.

Turning now to FIG. 1, one embodiment of the mobile, self-propelled, crop shading power generating structure 10 and system is shown schematically. The system structure 10 is a moving adjustable shade system for crops sensitive to intensive sunlight or livestock management, especially in hot, dry areas. This shade is movable and does not require a permanent structure to be placed in the field.

The moving module structure 10 is covered by solar panels 18, which can create the essential adjustable shade for crops to grow in summer and for animals to manage grazing practices. At the same time the module can generate electricity for its self-propelled towers as well as other auxiliary electrical equipment such as pumps, electric tractors, drones, and field robots, effectively acting as an electrical outlet in the field.

The module structure 10 in this embodiment has an optional irrigation subsystem 12 that can be connected to a conventional irrigation pumping station or pressurized water system. The water lines of the irrigation subsystem 12 of each module 10 can be interconnected to supply water to multiple module platforms. In the embodiment shown in FIG. 1, the irrigation subsystem water lines 12 have controlled sprayers or nozzles attached to vertical pipes 14 that are configured to dispense water around the perimeter and beneath the platform 16 to plants or animals that are below the platform 16. Plant water use will be decreased by decreasing the evapotranspiration rate with the use of temporally controllable shading.

The module 10 has a generally planar solar panel support platform 16 with rows of solar panels 18. The rows of panels 18 are mounted at an angle rather than mounted horizontally to improve the collection angle of the panels. In this case, the row angles alternate forming a ridge or peak between pairs of panel rows 18 in the embodiment shown in FIG. 1.

The panel platform 16 structure 16 can also have a planar top surface that can support both photovoltaic solar panels 18 and shade panels in a planar array. In one embodiment, the solar panels 18 or rows of panels can rotate about an axis to vary the created shade and/or maximize their electricity generation based on the position of the sun in the sky.

The panel platform structure 16 can also have attachments to the bottom surface of the platform such as plant growth sensors that can detect plant biotic and abiotic stresses as well as monitor plant growth rates. Sensors that that can detect water stress and plant locations can be used by the optional irrigation system to precisely irrigate plants or rows of plants based on their individual water needs. Other types of sensors may also be mounted to the bottom side of the platform 16. In one embodiment, lights capable of causing plant growth are mounted or suspended from the platform 16 at positions over the target crops.

The platform 16 is supported by four support towers or columns 20 located and mounted with a mounting structure 22 at the corners of the platform 16 in the embodiment shown in FIG. 1. The support towers 20 have one or more support legs 24 that extend from a mobile base. The mobile base has wheels 26 or a track that can preferably move in forward or backward rotating movements. The towers 20 are also driven by a mobility system 30 that has at least one motor, preferably an electric motor, and a gearbox. The movements of the wheels 26 of each of each tower 20 are preferably controlled by a central controller so that the towers can move in a coordinated way.

The tower 20 base may also have an electricity storage battery 28 that receives, and stores electricity produced by the solar panel 18 array. In one embodiment, the storage battery 28 is also electrically connected to the mobility system 30 so that the system power is self-generated, and the overall platform structure is self-propelled.

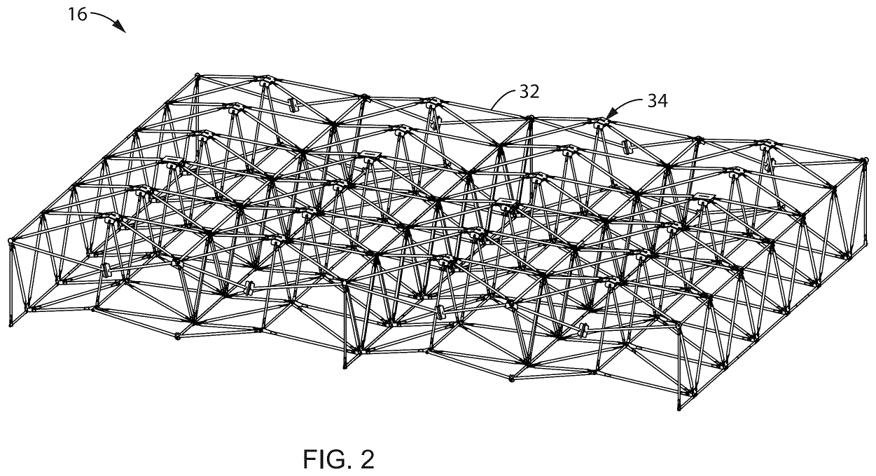

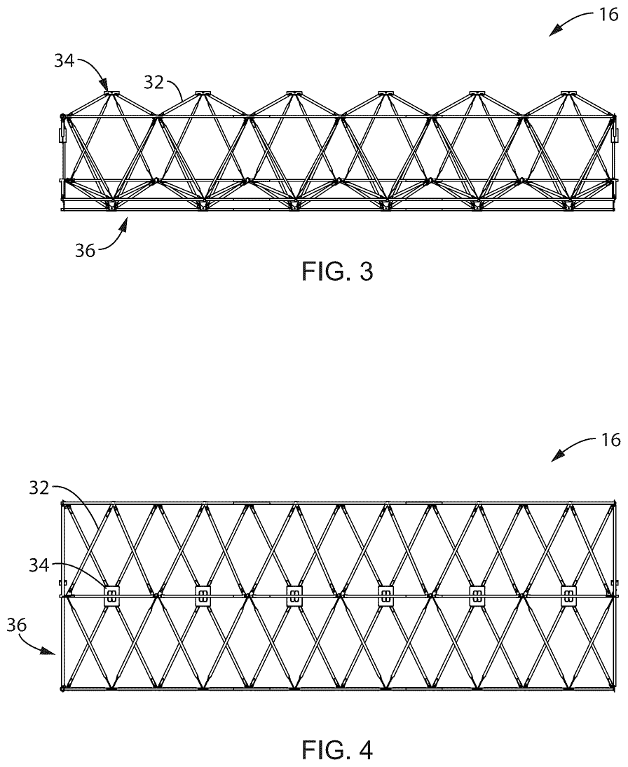

The panel support platform 16 is preferably a space structure (3D truss structure) made from light weight pipes 32 and joints 34 as illustrated in FIG. 2. Such a truss structure is preferably strong and durable that can withstand outside stresses from movements of the structure and the weather. The truss structure shown in FIG. 2, FIG. 3 and FIG. 4 is also scalable and modular and can be configured into square and rectangle shapes.

The top surface and the bottom surface of the platform 16 can also be configured for solar panels or rows of panels to be positioned at a specific angle for collection. As shown in the side view of FIG. 3 and the bottom view of FIG. 4, the top surface of the support platform 16 can be configured to have beneficial angles for solar collection and a bottom surface 36 that is generally planar.

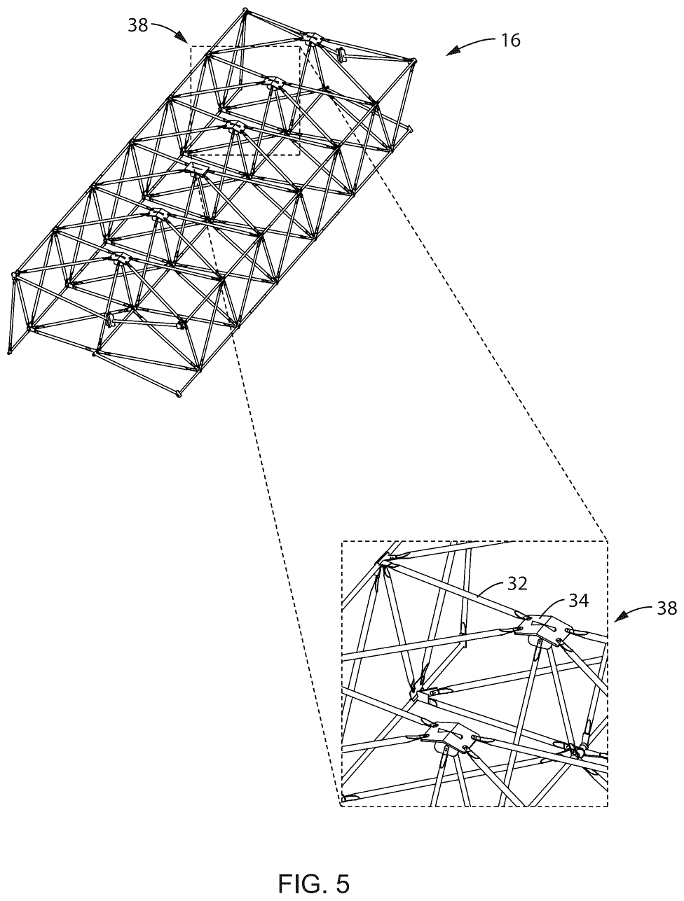

The corner features of the support platform 15 are preferably designed to couple with the tower 20 and to distribute the weight throughout the platform structure. As shown in FIG. 5, the corner of the truss structure 16 is adapted to couple with the vertical column or tower 20 support at two to four points. Although the platform 16 is coupled to the tower 20 in the far corners, it will be understood that the coupling point of the towers can be at other locations along the periphery of the platform 16 and not limited to the far corners. In addition, more than two or four mobile platform support towers can be used to support the platform 16 depending on the selected dimensions of the platform.

As shown in FIG. 5, the truss structure of the platform 16 can be made from repeating structural units that can be reinforced at the various tower 20 coupling contact points 38. The volume and thickness of the truss platform structure can also be determined by the selection of truss pipe lengths.

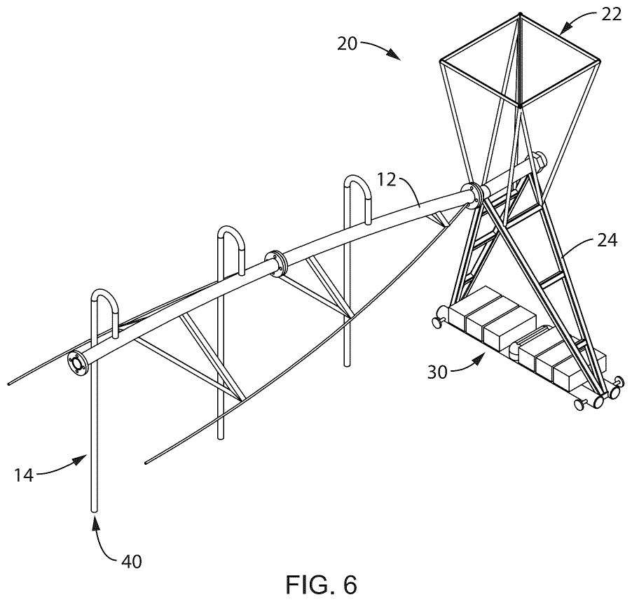

The height of the structure and the distance between the bottom surface 36 of platform 16 can be determined by the dimensions of the towers 20. In the embodiment shown in FIG. 6, the height of the tower 20 is static and generally determined by the length of the support legs 24 and the size of the platform mounting structure 22. In another embodiment, the tower structure may be dynamic with telescoping or other structures to raise and lower the level of the platform.

Vertical pipes 14 may be positioned along the main distribution pipe of the irrigation system 12 to dispense water through sprayers or nozzles 40 in this embodiment. The length of the vertical pipes 14 can be adjusted to control the distance between the nozzle or sprayer 40 and the plants.

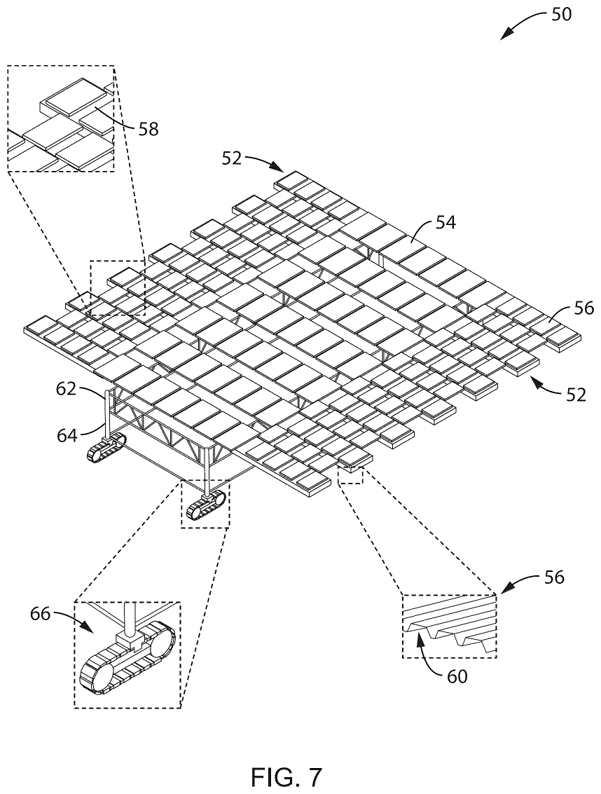

An alternative embodiment of the self-powered, self-propelled, mobile shade and power generating system 50 is shown in FIG. 7. In this embodiment, the platform 52 of the system 50 has a generally planar top surface of rows of solar panels 54 and shade panels 56. Gaps between both the solar panels 54 and the shade panels 56 allow controlled amounts of sunlight to go through the platform 52. In one embodiment, the shade panels 56 can slide along channels to increase or decrease the gaps 58 between the shade panels 56. In one embodiment, the shade panels 56 and the solar panels 54 can pivot on a central axel to allow further control over the sun exposures and shade.

In this embodiment, the support platform 62 has columns 64 that are telescoping and coupled to each corner of the planar beam structure 62 with a ball joint or other pivoting joint that allows the beam structure 62 to move relative to the column 64. The base of the column 64 has a motorized track. Here, the extension or retraction of each of the columns 62 changes the position of the plane of the beam platform structure. The telescoping columns 62 also allow the plane of the platform structure to remain level when the tracks 66 are on uneven or irregular soil surfaces.

The underside 60 of the shade panels 56 or the solar panels 54 or platform 16 may have growth promoting lights directed to the plants below. In one embodiment, LED light bars are positioned inside of the shaded area of the machine and can be used during the nighttime to increase the duration of plant exposure to growth light, which in turn increases the plant growth rate and increases the profit of crop production for growers through the feasibility of having two production seasons in one growing season.

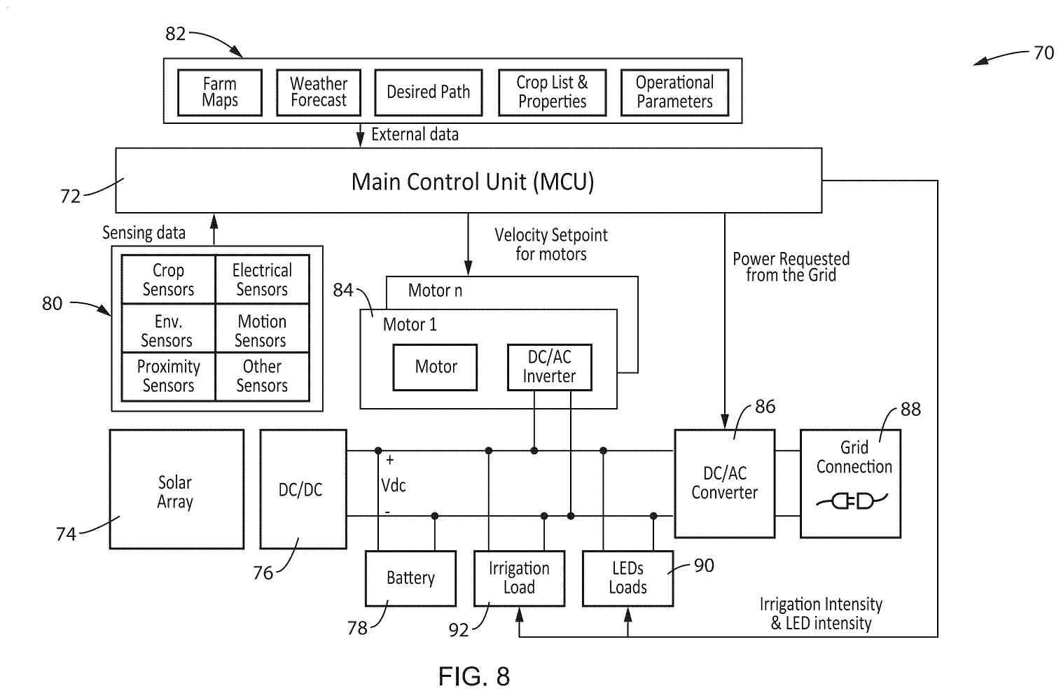

Referring now to FIG. 8, a block diagram of one embodiment of a Main Control Unit (MCU) control system 70 suitable for use in the present system is illustrated. A mobile shade and power generation platform with solar panel and shade panel structures that is supported by a (3D truss structure), vertical columns or towers that each have a controllable motorized wheeled base, irrigation system and sensors are controlled by the MCU in this illustration.

Generally, the MCU system 70 provides control over a mechanical subsystem, an electrical subsystem, and a sensor subsystem using a general-purpose computer and programming in this embodiment. In other embodiments, primary control over the action of the functional elements of each platform is provided by a master control unit and instructions are transmitted to an MCU located on the mobile platform.

In this illustration, the mechanical subsystem has control over movement and direction of the motorized wheels or tracks of each tower/column of the platform structure. This may include position sensors such as proximity sensors and GPS sensors. The mechanical subsystem also has control over the valves and metering of the optional irrigation system of the platform.

The electrical subsystem has control over the solar panels, grid junction boxes, power production meters and optional storage batteries. The positioning of the solar panels and the position of the shade panels for controlling solar exposure as well as optimizing solar panel generation is controlled by the MCU electrical subsystem. In addition, the electrical subsystem has control over one or more LED light bars that may be used to increase light exposure for plant growth as well as any external lights for lighting portions of the structure. When configured for livestock, managed grazing techniques can be implemented. The electrical subsystem may also control cooling fans and automatic feed and water dispensers.

In the sensor subsystem shown in this illustration, various types of sensors that can be used to monitor plant growth and vigor as well as the environment are mounted to the underside of the platform or to a tower. Preferred sensors for monitoring plant status includes: 1) multi-spectral sensors with 10 bands; 2) a 3D Lidar system to monitor the plant height; and thermal image sensors. Environmental sensors such as temperature sensors, humidity sensors, wind sensors can also provide data to, and be controlled by, the sensor subsystem. In one embodiment, the data produced by the sensors of the sensor subsystem can be transmitted to a remote computer control location for processing. Decisions regarding irrigation volume, watering locations, solar illumination or shade needs, fertilizer or pest control needs, and the like can be assisted by the sensor data.

The MCU control system 70, shown in the block diagram in FIG. 8, has a main control unit 72 that controls the mechanical subsystem, electrical subsystem, sensor subsystem and optional communications. The MCU main control unit 72 generally computes the control signals for the multiple actuators available in the mobile agrivoltaic system. Examples of actuators include traction electrical motors, irrigation loads, LED, DC/AC inverters to regulate the power injected by the system into the power grid (in the case where a grid connection is available), and actuators that change the orientation of the solar panels.

The power production features (i.e. a solar array 74 and/or wind turbine) and distribution features of the platform are controlled by the main control unit 72. In this embodiment, the array of solar panels 74, positioned at the top of the moving shade structure to create shade for the crops, generates electricity. Through a DC/DC converter 76 the generated power can run the machine itself or it can be stored in on-board rechargeable batteries 78. Extra generated electric power from the panels of the array 74 or wind turbine may alternatively be transferred to a farm power hub 88 where it either directly powers electrical farm equipment or stored in remote batteries or hydrogen tank for later use.

The electrical subsystem of the MCU control system 70 also controls the actuation, speed, velocity set point, and duration of the actions of each motor 84. Optionally, the MCU can control the direction of the wheels or tracks if equipped with an optional steering system. Power for the movement of the platform with the motors 84 may come from the solar array 74 and battery 78 so that the mobile platform is self-sufficient.

Power for the motors 84 and system 70 may also be obtained from outside of the mobile platform system though the grid connection 88 and a DC/AC converter 86. Power through the grid connection 88 can be helpful when the mobile platform needs to be moved distances that exceed the capacity of the on-board batteries and direct solar panel production.

The MCU control unit 72 may also receive information from multiple onboard sensors 80. This onboard sensing data may be processed and interpreted by MCU programming and provide a basis for specific actions by the platform system. The sensors 80 may include, for example: (i) motion sensors from wheel encoders, inertial measurement units, GPS for navigation; (ii) crop-based sensors that measure crop growth, plant height, water stress, soil and environmental conditions; (iii) electrical sensors to measure voltage and current in different parts of the platform (e.g., solar panels, battery, etc.); and (iv) proximity-based sensors that measure the distance to nearby obstacles.

Based on one or more of different types of data and the MCU programming set parameters, the MCU functions to provide velocity setpoints for the motors in the system, request power from the grid, control irrigation intensity and LED intensity, provide for battery usage and charging from a solar array, etc. The MCU controller 72 and programming can also be parameterized in order to obtain a good balance between energy generated by the solar panels' vs crop growth factors and yield.

The MCU can also receive external information 82, such as digital farm maps, weather forecasts, lists of crops and properties, operational parameters and desired paths (position and orientation) for the mobile system requested by the user or by the farm management system. The external data 82 can be used alone or with sensor data 80 from sensors by the MCU programming to determine daily shade and sunlight exposure durations, to initiate or postpone irrigation spray events, and solar power production. For example, the MCU control programming can calculate and control the irrigation load 92 with control over spray volumes and timing in view of air temperatures and crop status in this illustration. Similarly, the MCU control programming can calculate and control the LED bank 90 illumination intensity, actuation and duration based on sensor data and an assessment of the temporal illumination needs of the crop.

The MCU control unit 72 calculates the command signals capable of optimizing multiple energy, crop, and economic objectives while fulfilling operational and safety constraints. Crop objectives include, for example, crop growth factors, yield, water usage, and fertilizer needs. Operational constraints include, for example, avoiding collision with obstacles, avoiding moving over the crop with the platform's tires, limiting the position and orientation deviations from the desired path, and reducing the mechanical stress/bending forces due to asymmetric torques applied to the mobile platform by the motors.

The MCU can also have an internal mathematical model that predicts key states for the growth of the crops, such as biomass, yield, and canopy temperature. These models can combine plant's physiological models with machine-learning models (e.g., deep neural networks) to improve prediction accuracy.

The MCU control unit 72 programming can operate in open-loop and closed-loop modes. The open-loop strategy pre-programs the platform at the beginning of the growing season using historical environmental patterns and the calibrated crop's growth models; this approach is easy to implement and affordable (e.g., limits the need for sensing), but is highly dependent on the crop model and historical data, which might introduce significant prediction errors.

The closed-loop strategy uses real-time feedback information from the onboard to adapt the control actions over time. In this case, the MCU's multi-objective optimization problem is periodically solved using new sensing data. It enables the control algorithm to respond and compensate for model mismatches and environmental disturbances that the crop experiences throughout the growing season; however, it is more complex to implement and might require additional hardware (sensors).

To reduce the computational complexity of the MCU, the calculation of the control signals can be divided into two layers that operate with different time scales. The high layer focuses on slow crop dynamics (time scale of days) and considers crop growth models and long-term weather forecasts in the assessment. The low-level layer considers fast crop dynamics (time scale of minutes) and considers the evapotranspiration, photosynthesis, and response of the crop.

It will also be appreciated that the mobile system described herein has various aspects and features that can be configured to accommodate and optimize the temporal light needs of different plant crops, particularly heat sensitive crops. Other configurations can be directed to the shade needs of various types of livestock that may include cooling fans as well as sprayers to reduce the occurrence of heat exhaustion or hyperthermia in the animals. At the same time, the solar power generation of solar panels can also be optimized and stored so that the system is self-sustaining.

Other beneficial aspects, features and configurations of the mobile shade and power generation system include the following:
(a) The system can be equipped with sensors to detect biotic and abiotic stress in plants. It can also be equipped with computer vision systems to measure crop growth rate and detect weeds. Robotic arms or laser systems may be used to remove weeds.
(b) The system may include an irrigation system that uses a sensor on board that can perform precision irrigation. By optimum use of water, the system can reduce evapotranspiration and reduce water usage for crop production.
(c) The cooling effect, caused by irrigation of plants grown under solar panels, will enhance the efficiency of the solar panels.
(d) The system may include an irrigation system and LED light bars to increase the controllability of plant growth for growers and decrease the length of the growing season.
(e) There is no permanent structure required in the field, therefore during the harvest and other field operations, the system can be moved out of the way, and conventional agricultural machinery can be used.
(f) The system may have a modular structure and can be scaled up and down to increase the coverage area and electricity power output which accommodates different sizes of farms or orchards at different times of the season.
(g) The system can accommodate many different types of crops that have different light saturation points, heat tolerances, water needs, and growing condition requirements.
(h) The system may be configured to function as a power hub to charge the batteries of electrical tractors, drones, and robots in the field.
(i) The system may be retrofitted with soil and plant sensors and monitor crop growth and health. It can also provide the necessary structure for wireless communication for data collected from the sensors.
(j) The system can be equipped with light sources, such as LEDs, that provide growth initiating light to extend the plant growth rate at night and increase the growth rate of plants.
(k) The system can serve as an emergency source of energy for local communities and farmhouses during emergencies.
(l) The system can provide a controlled amount of shade based on the need of the crop.
(m) The system can reduce the amount of water usage by plants by reducing the amount of evapotranspiration.
(n) The system can be used as a moving shelter for managed grazing of animals such as cows, sheep, and goats on the farm.

Embodiments of the technology of this disclosure may be described herein with reference to flowchart illustrations of methods and systems according to embodiments of the technology. Embodiments of the technology of this disclosure may also be described with reference to procedures, algorithms, steps, operations, formulae, or other computational depictions, which may be included within the flowchart illustrations or otherwise described herein. It will be appreciated that any of the foregoing may also be implemented as computer program instructions. In this regard, each block or step of a flowchart, and combinations of blocks (and/or steps) in a flowchart, as well as any procedure, algorithm, step, operation, formula, or computational depiction can be implemented by various means, such as hardware, firmware, and/or software including one or more computer program instructions embodied in computer-readable program code. As will be appreciated, any such computer program instructions may be executed by one or more computer processors, including without limitation a general purpose computer or special purpose computer, or other programmable processing apparatus to produce a machine, such that the computer program instructions which execute on the computer processor(s) or other programmable processing apparatus create means for implementing the function(s) specified.

Accordingly, blocks of the flowcharts, and procedures, algorithms, steps, operations, formulae, or computational depictions described herein support combinations of means for performing the specified function(s), combinations of steps for performing the specified function(s), and computer program instructions, such as embodied in computer-readable program code logic means, for performing the specified function(s). It will also be understood that each block of the flowchart illustrations, as well as any procedures, algorithms, steps, operations, formulae, or computational depictions and combinations thereof described herein, can be implemented by special purpose hardware-based computer systems which perform the specified function(s) or step(s), or combinations of special purpose hardware and computer-readable program code.

Furthermore, these computer program instructions, such as embodied in computer-readable program code, may also be stored in one or more computer-readable memory or memory devices that can direct a computer processor or other programmable processing apparatus to function in a particular manner, such that the instructions stored in the computer-readable memory or memory devices produce an article of manufacture including instruction means which implement the function specified in the block(s) of the flowchart(s). The computer program instructions may also be executed by a computer processor or other programmable processing apparatus to cause a series of operational steps to be performed on the computer processor or other programmable processing apparatus to produce a computer-implemented process such that the instructions which execute on the computer processor or other programmable processing apparatus provide steps for implementing the functions specified in the block(s) of the flowchart(s), procedure(s) algorithm(s), step(s), operation(s), formula (e), or computational depiction(s).

It will further be appreciated that the terms “programming” or “program executable” as used herein refer to one or more instructions that can be executed by one or more computer processors to perform one or more functions as described herein. The instructions can be embodied in software, in firmware, or in a combination of software and firmware. The instructions can be stored locally to the device in non-transitory media or can be stored remotely such as on a server, or all or a portion of the instructions can be stored locally and remotely. Instructions stored remotely can be downloaded (pushed) to the device by user initiation, or automatically based on one or more factors.

It will further be appreciated that as used herein, the terms controller, microcontroller, processor, microprocessor, hardware processor, computer processor, central processing unit (CPU), and computer are used synonymously to denote a device capable of executing the instructions and communicating with input/output interfaces and/or peripheral devices, and that the terms controller, microcontroller, processor, microprocessor, hardware processor, computer processor, CPU, and computer are intended to encompass single or multiple devices, single core and multicore devices, and variations thereof.

From the description herein, it will be appreciated that the present disclosure encompasses multiple implementations of the technology which include, but are not limited to, the following:

A mobile platform, comprising: (a) a platform with a top surface and a bottom surface; (b) a plurality of shade panels mounted on the top surface of the platform; and (c) a plurality of mobile support towers coupled to the platform, said towers capable of moving the platform from one location to another.

The mobile platform of any preceding or following implementation, each said support tower further comprising (a) one or more wheels; and (b) a motor and transmission operably coupled to at least one wheel.

The mobile platform of any preceding or following implementation, each said support tower further comprising (a) a continuous track; and (b) a motor and transmission operably coupled to the continuous track.

The mobile platform of any preceding or following implementation, each said support tower further comprising at least one battery configured as a power source for the motor; and a motor controller.

The mobile platform of any preceding or following implementation, each said support tower further comprising: a telescoping column configured to increase or decrease in length and thereby increase or decrease the height of the platform.

The mobile platform of any preceding or following implementation, wherein said shade panels comprise an array of solar panels.

The mobile platform of any preceding or following implementation, further comprising a solar or shade panel support structure configured to allow each solar or shade panel to move around an axis and be dynamically oriented for optimum solar collection or shade.

The mobile platform of any preceding or following implementation, further comprising a solar or shade panel support structure configured to allow rows of solar or shade panels to move around an axis and be dynamically oriented for optimum solar collection or shade.

The mobile platform of any preceding or following implementation, further comprising auxiliary growth lights mounted to the bottom surface of the platform to improve crop growth rate and quality.

The mobile platform of any preceding or following implementation, further comprising: a plurality of environmental sensors mounted to the platform to monitor environmental conditions beneath the platform.

The mobile platform of any preceding or following implementation, further comprising one or more auxiliary fans mounted to the bottom surface of the platform to create movement of air beneath the platform.

A mobile, scalable, self-powered agrivoltaic system, comprising: (a) a support structure; (b) a plurality of motorized towers attached to the support structure and configured to move the support structure from location to loc (c) a plurality of solar panels attached to the support structure, said solar panels configured to provide shade to crops, said solar panels configured to provide electrical power to the motorized towers; (d) an irrigation system attached to the support structure and configured to provide irrigation to crops; and (e) a sensor system configured to monitor crop moisture and deploy the irrigation system when crop irrigation is required.

The mobile platform of any preceding or following implementation, further comprising a solar panel support structure configured to allow each solar panel to move around an axis and be dynamically oriented for optimum solar collection.

The mobile platform of any preceding or following implementation, further comprising a solar panel support structure configured to allow rows of solar panels to move around an axis and be dynamically oriented for optimum solar collection.

The system of any preceding or following implementation, further comprising a battery storage system connected to the solar panels and configured to store power for operating the motorized towers and for providing power to auxiliary equipment.

The system of any preceding or following implementation, further comprising a plurality of light bars attached to the support structure beneath the solar panels and configured to provide light of wavelengths that will promote plant growth at nighttime.

The system of any preceding or following implementation, further comprising sensors attached to the support structure and configured to monitor plant growth rates and detect plant biotic and abiotic stresses.

The system of any preceding or following implementation, further comprising one or more sensors attached to the support structure selected from the group of sensors consisting of electrical sensors, motion sensors, proximity sensors, GPS sensors, environmental condition sensors, thermal sensors, irrigation load sensors and LED load sensors.

The system of any preceding or following implementation, further comprising a main control unit (MCU) with a processor and non-transitory memory storing instructions executable by the processor for controlling a mechanical subsystem, an electrical subsystem and a sensor subsystem.

A mobile agrivoltaic system, comprising (a) a support structure with a plurality of solar panels and shade panels attached to the support structure, said solar and shade panels configured to provide shade to crops, said solar panels configured to produce electrical power; (b) a plurality of mobile support columns attached to the support structure, said mobile support columns having a motor, transmission, battery power source and wheels configured to move the support structure from location to location; (d) an irrigation system attached to the support structure and configured to provide irrigation to crops; (e) a sensor system configured to monitor crop moisture and deploy the irrigation system when crop irrigation is required; and (f) a control system configured to control the solar panel electricity production, the motor, the irrigation system and the sensor system.

As used herein, the term “implementation” is intended to include, without limitation, embodiments, examples, or other forms of practicing the technology described herein.

As used herein, the singular terms “a,” “an,” and “the” may include plural referents unless the context clearly dictates otherwise. Reference to an object in the singular is not intended to mean “one and only one” unless explicitly so stated, but rather “one or more.”

Phrasing constructs, such as “A, B and/or C”, within the present disclosure describe where either A, B, or C can be present, or any combination of items A, B and C. Phrasing constructs indicating, such as “at least one of” followed by listing a group of elements, indicates that at least one of these groups of elements is present, which includes any possible combination of the listed elements as applicable.

References in this disclosure referring to “an embodiment”, “at least one embodiment” or similar embodiment wording indicates that a particular feature, structure, or characteristic described in connection with a described embodiment is included in at least one embodiment of the present disclosure. Thus, these various embodiment phrases are not necessarily all referring to the same embodiment, or to a specific embodiment which differs from all the other embodiments being described. The embodiment phrasing should be construed to mean that the particular features, structures, or characteristics of a given embodiment may be combined in any suitable manner in one or more embodiments of the disclosed apparatus, system, or method.

As used herein, the term “set” refers to a collection of one or more objects. Thus, for example, a set of objects can include a single object or multiple objects.

Relational terms such as first and second, top and bottom, upper and lower, left and right, and the like, may be used solely to distinguish one entity or action from another entity or action without necessarily requiring or implying any actual such relationship or order between such entities or actions.

The terms “comprises,” “comprising,” “has”, “having,” “includes”, “including,” “contains”, “containing” or any other variation thereof, are intended to cover a non-exclusive inclusion, such that a process, method, article, apparatus, or system, that comprises, has, includes, or contains a list of elements does not include only those elements but may include other elements not expressly listed or inherent to such process, method, article, apparatus, or system. An element proceeded by “comprises . . . a”, “has a”, “includes . . . a”, “contains . . . a” does not, without more constraints, preclude the existence of additional identical elements in the process, method, article, apparatus, or system, that comprises, has, includes, contains the element.

As used herein, the terms “approximately”, “approximate”, “substantially”, “substantial”, “essentially”, and “about”, or any other version thereof, are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

The term “coupled” as used herein is defined as connected, although not necessarily directly and not necessarily mechanically. A device or structure that is “configured” in a certain way is configured in at least that way but may also be configured in ways that are not listed.

Benefits, advantages, solutions to problems, and any element(s) that may cause any benefit, advantage, or solution to occur or become more pronounced are not to be construed as a critical, required, or essential feature or element of the technology described herein or any or all the claims.

In addition, in the foregoing disclosure various features may be grouped together in various embodiments for the purpose of streamlining the disclosure. This method of disclosure is not to be interpreted as reflecting an intention that the claimed embodiments require more features than are expressly recited in each claim. Inventive subject matter can lie in less than all features of a single disclosed embodiment.

The abstract of the disclosure is provided to allow the reader to quickly ascertain the nature of the technical disclosure. It is submitted with the understanding that it will not be used to interpret or limit the scope or meaning of the claims.

It will be appreciated that the practice of some jurisdictions may require deletion of one or more portions of the disclosure after the application is filed. Accordingly, the reader should consult the application as filed for the original content of the disclosure. Any deletion of content of the disclosure should not be construed as a disclaimer, forfeiture, or dedication to the public of any subject matter of the application as originally filed.

All text in a drawing figure is hereby incorporated into the disclosure and is to be treated as part of the written description of the drawing figure.

The following claims are hereby incorporated into the disclosure, with each claim standing on its own as a separately claimed subject matter.

Although the description herein contains many details, these should not be construed as limiting the scope of the disclosure, but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. A mobile platform, comprising:
(a) a platform with a top surface and a bottom surface;
(b) a plurality of shade panels mounted on the top surface of the platform; and
(c) a plurality of mobile support towers coupled to the platform, said towers capable of moving the platform from one location to another.

2. The mobile platform of claim 1, each said support tower further comprising:
(a) one or more wheels; and
(b) a motor and transmission operably coupled to at least one wheel.

3. The mobile platform of claim 1, each said support tower further comprising:
(a) a continuous track; and
(b) a motor and transmission operably coupled to the continuous track.

4. The mobile platform of claim 2, each said support tower further comprising:
at least one battery configured as a power source for the motor; and
a motor controller.

5. The mobile platform of claim 1, each said support tower further comprising:
a telescoping column configured to increase or decrease in length and thereby increase or decrease the height of the platform.

6. The mobile platform of claim 1, wherein said shade panels comprise an array of solar panels.

7. The mobile platform of claim 1, further comprising:
a solar or shade panel support structure configured to allow each solar or shade panel to move around an axis and be dynamically oriented for optimum solar collection or shade.

8. The mobile platform of claim 1, further comprising:
a solar or shade panel support structure configured to allow rows of solar or shade panels to move around an axis and be dynamically oriented for optimum solar collection or shade.

9. The mobile platform of claim 1, further comprising:
auxiliary growth lights mounted to the bottom surface of the platform to improve crop growth rate and quality.

10. The mobile platform of claim 1, further comprising:
a plurality of environmental sensors mounted to the platform to monitor environmental conditions beneath the platform.

11. The mobile platform of claim 1, further comprising:
one or more auxiliary fans mounted to the bottom surface of the platform to create movement of air beneath the platform.

12. A mobile, scalable, self-powered agrivoltaic system, comprising:
(a) a support structure;
(b) a plurality of motorized towers attached to the support structure and configured to move the support structure from location to location;
(c) a plurality of solar panels attached to the support structure, said solar panels configured to provide shade to crops, said solar panels configured to provide electrical power to the motorized towers;
(d) an irrigation system attached to the support structure and configured to provide irrigation to crops; and
(e) a sensor system configured to monitor crop moisture and deploy the irrigation system when crop irrigation is required.

13. The mobile platform of claim 12, further comprising:
a solar panel support structure configured to allow each solar panel to move around an axis and be dynamically oriented for optimum solar collection.

14. The mobile platform of claim 12, further comprising:
a solar panel support structure configured to allow rows of solar panels to move around an axis and be dynamically oriented for optimum solar collection.

15. The system of claim 12, further comprising:
a battery storage system connected to the solar panels and configured to store power for operating the motorized towers and for providing power to auxiliary equipment.

16. The system of claim 15, further comprising:
a plurality of light bars attached to the support structure beneath the solar panels and configured to provide light of wavelengths that will promote plant growth at nighttime.

17. The system of claim 12, further comprising:
sensors attached to the support structure and configured to monitor plant growth rates and detect plant biotic and abiotic stresses.

18. The system of claim 12, further comprising:
one or more sensors attached to the support structure selected from the group of sensors consisting of electrical sensors, motion sensors, proximity sensors, GPS sensors, environmental condition sensors, thermal sensors, irrigation load sensors and LED load sensors.

19. The system of claim 12, further comprising:
a main control unit (MCU) with a processor and non-transitory memory storing instructions executable by the processor for controlling a mechanical subsystem, an electrical subsystem and a sensor subsystem.

20. A mobile agrivoltaic system, comprising:
(a) a support structure with a plurality of solar panels and shade panels attached to the support structure, said solar and shade panels configured to provide shade to crops, said solar panels configured to produce electrical power;
(b) a plurality of mobile support columns attached to the support structure, said mobile support columns having a motor, transmission, battery power source and wheels configured to move the support structure from location to location;
(c) an irrigation system attached to the support structure and configured to provide irrigation to crops;
(d) a sensor system configured to monitor crop moisture and deploy the irrigation system when crop irrigation is required; and
(e) a control system configured to control the solar panel electricity production, the motor, the irrigation system and the sensor system.
